(19) United States
(12) Patent Application Publication
(10) Pub. No.: US 2024/0341273 A1
(43) Pub. Date: Oct. 17, 2024

(54) MAGNET DEVICE FOR A FEED MIXING WAGON OR A STATIONARY FEED MIXER

(71) Applicant: MAYER VERWALTUNGS GmbH & CO. KG, Tittmoning (DE)

(72) Inventor: Hauler ATTILA, Burgkirchen (DE)

(21) Appl. No.: 18/634,256

(22) Filed: Apr. 12, 2024

(30) Foreign Application Priority Data
Apr. 14, 2023 (DE) 10 2023 109 454.8

(51) Int. Cl. A01K 5/00

(52) U.S. Cl. CPC A01K 5/004

(57) ABSTRACT

A magnet device for a feed mixing wagon including at least one magnet and a separator. The separator and the at least one magnet are arranged so that they can move relative to one another in order to be brought from a first operating position into a second operating position. The separator is arranged in the first operating position relative to the at least one magnet in such a way that the separator shields the at least one magnet, so that metal parts to be separated from feed are pulled onto the separator by the magnet and held thereon. The separator is spaced further apart from the at least one magnet in the second operating position than in the first operating position.

### CROSS RELATED APPLICATION

This application claims priority to German Application DE 10 2023 109 454.8, filed Apr. 14, 2023, the entire contents of which is hereby incorporated by reference.

### FIELD OF THE INVENTION

The present invention relates to a magnet device for a feed mixing wagon or a stationary feed mixer, to a mixing auger for a feed mixing wagon or a stationary feed mixer comprising a magnet device, and to a corresponding feed mixing wagon or a stationary feed mixer. Furthermore, the present invention relates to a method for removing magnetic metal parts from a feed mixing wagon or from a stationary feed mixer by means of the magnet device.

### BACKGROUND

It is known that feed mixing wagons and stationary feed mixers are used to mix animal feed in the form of grass silage, maize silage, hay, concentrated feed and the like. While a stationary feed mixer is immovable, a feed mixing wagon can transport the mixed feed to the feeding point and dispense it there. For the mixing, feed mixing wagons and stationary feed mixers have a mixing hopper and respectively a feed mixing wagon hopper with a base and a peripheral wall (hopper wall), which extends upwards from the base in a predominantly vertical or sloping direction. Mixing is effected by means of one or more mixing augers, which are arranged inside the mixing hopper/feed mixing wagon hopper with a usually vertical rotational axis. The mixing augers typically have a conical outer contour, i.e. the auger diameter is larger in the area near the base than in the upper end area.

In addition, the mixing augers can have at least one magnet, which has the task of separating metal parts, i.e. ferromagnetic, ferritic or partially ferritic material such as steel parts, steel shavings, nails, pure iron or cast iron, from the feed to be mixed and of holding them in place through the naturally or electrically generated magnetic effect, so as to prevent the animals to be fed from being injured by any metal parts in the feed. Such mixing augers are known, for example, from EP 3 959 969 A1.

When positioning the/the magnet(s) it is a challenge not to disturb the mixing process with the/the magnet(s). At the same time, in order to maximise the separation rate, the at least one magnet must be arranged in such a way that the metal parts to be separated are effectively separated and continue to adhere to the at least one magnet despite the rotation of the mixing auger.

It is possible to maximise the separation rate by, for example, using very powerful magnets. However, particularly in the case of permanent magnets, the use of powerful magnets makes it difficult to remove the separated metal parts, as they adhere very strongly on the permanent magnet. This strong adherence and the associated high forces needed to release the separated metal parts increase the risk of injury (e.g. due to slipping and unintentional contact with flights of the mixing auger which are sometimes equipped with blades) and the risk of damaging the mixing auger or the feed mixing wagon hopper. In addition, it is often only possible to release the separated metal parts by means of non-magnetic tools, made of copper or aluminium, for example.

The use of electromagnets, which can be switched off for the removal of the separated metal parts, is often undesirable or not possible, as the electrical energy required would have to be supplied to the electromagnets on the rotating mixing auger.

The object of the present invention is therefore to a achieve a high separation rate while simultaneously making it easier to remove the separated metal parts.

### DESCRIPTION OF THE INVENTION

The above object is achieved by a magnet device for a feed mixing wagon or a stationary feed mixer, by a mixing auger for a feed mixing wagon or a stationary feed mixer, and by a corresponding feed mixing wagon and a stationary feed mixer according to the independent claims. The object is also achieved by a method for removing magnetic metal parts from a feed mixing wagon. Further aspects of the invention are specified in the dependent claims and described hereinbelow.

The object is achieved in particular by a magnet device for a feed mixing wagon or a stationary feed mixer. The magnet device can be designed to be arranged on a mixing auger of the feed mixing wagon (or of the stationary feed mixer), in a mixing hopper of the feed mixing wagon (in particular on a hopper wall, preferably in the base region of the hopper wall) or of the stationary feed mixer, in a discharge area or on a discharge means of the feed mixing wagon or of the stationary feed mixer, such as for example on a discharge belt conveyor of the feed mixing wagon or of the stationary feed mixer and/or at another suitable point on the feed mixing wagon or the stationary feed mixer. A corresponding feed mixing wagon or stationary feed mixer can comprise a plurality of magnet devices described hereinbelow. These can be arranged at different points and/or on different components of the feed mixing wagon or the stationary feed mixer (e.g. on a mixing auger, in a mixing hopper (or on a hopper wall), and/or on a discharge belt conveyor). A discharge means, such as a discharge belt conveyor, is used to convey the mixed feed (in an automated manner) from the mixing hopper of the feed mixing wagon (feed mixing wagon hopper) in order to carry out feeding, for example. It goes without saying that the feed can also be conveyed from the feed mixing wagon in another automated manner. Appropriate discharge means (e.g. auger conveyors, pushers, belt conveyors, etc.) can be provided for this purpose. The magnet device can be arranged on such a discharge means.

The magnet device comprises at least one magnet and a separator, wherein the separator and the at least one magnet are arranged so as to be able to move relative to one another in order to be brought from a first operating position into a second operating position. An operating position is characterised by the spatial orientation of the separator relative to the at least one magnet, wherein the operating position can be changed (e.g. from the first to the second operating position) by a movement of the at least one magnet and/or by a movement of the separator. By changing the operating position, the magnetic field acting on the separator changes.

In particular, the magnet device can comprise a single magnet or a plurality (at least two) of magnets that interact. If a plurality of magnets are part of the magnet device, these magnets can be connected, for example adhesively bonded, to one another. It is likewise possible that the plurality of magnets adhere to one another due to action of the magnetic forces. In addition, the magnets can be held in a corresponding magnet holder in the magnet device. The magnet/the magnets are in particular permanent magnets, such as neodymium magnets or ferrite magnets. The magnet/the magnets can also comprise at least one electromagnet.

In the first operating position, the separator is arranged relative to the at least one magnet in such a way that the separator shields the at least one magnet. The shielding is in particular three-dimensional, so that metal parts to be separated from feed are pulled onto the separator and held there by means of the magnet (or the magnets) if the magnet device is arranged in a feed mixing wagon hopper (e.g. on a mixing auger) for example. Therefore, the metal parts to be separated can be prevented from adhering directly to the magnet/the magnets. The separator thus separates the metal parts to be separated from the magnet(s).

In particular, the separator can be configured in such a way that it does not or does not significantly shield or change the magnetic field of the magnet(s).

The separator is spaced further apart from the at least one magnet in the second operating position than in the first operating position. The magnetic field acting on the separator is therefore weaker in the second operating position than in the first operating position. The metal parts held against or on the separator due to the action of the magnetic field are therefore easier to remove in the second operating position than in the first operating position.

By way of example, the magnetic field can be weakened in the second operating position to such an extent that ferromagnetic metal parts can be removed from the separator without using any tools (i.e. by hand). Likewise, the magnetic field can be weakened in the second operating position to such an extent that the metal parts fall or slip from the separator.

In one aspect of the invention, the magnetic field acting on the separator can be reduced in the second operating position by at least a factor of 2, or by at least a factor of 4, or by at least a factor of 8 or by at least a factor of 16 compared to the magnetic field acting on the separator in the first operating position. The magnetic force acting on the metal parts to be separated is reduced accordingly in the second operating position. Generally, the magnetic force between two magnetic bodies is inversely proportional to the square of the distance between the magnetic poles or the bodies. To reduce the acting magnetic field or magnetic force by a factor of 4, for example, the distance between magnet and separator in the second operating position needs to be twice the size of that in the first operating position.

According to one aspect, the separator is weakly magnetic or not magnetic. In particular, the separator can be manufactured from a weakly magnetic metal, such as stainless steel (here, for example, 1.4305, 1.4300, 1.4031, 1.4303, 1.4306, 1.4307, 1.4310, 1.4316, 1.4318, 1.4401, 1.4404, 1.4405, 1.4406 or 1.4021). Likewise, the separator can be manufactured from a non-magnetic metal or from a plastic (thermoplastic, thermoset or elastomer (in particular rubber)) and/or comprise this. In addition, the separator can be manufactured from a non-magnetic or weakly magnetic composite material, such as from a fibre-reinforced plastic. If the separator is not magnetic (or is weakly magnetic), it does not adhere to the magnet(s) even in the first operating position (or it adheres only slightly thereto) and can thus easily be brought into the second operating position. The removal of metal parts to be separated can thus be simplified.

The magnet device can furthermore comprise a housing which at least partially accommodates the at least one magnet. The separator can be part of the housing. In particular, the housing can comprise a magnet holder, which holds the magnet/the magnets in the housing. The housing can in addition be designed to be arranged on a further component of the feed mixing wagon or the stationary feed mixer, such as on the mixing auger, for example. At least one mounting apparatus can be provided on the housing for this purpose. For example, the housing can be screwed onto a mixing auger. The mounting apparatus can then comprise at least one threaded bolt and/or at least one receptacle that can accommodate a corresponding threaded bolt.

It is also possible that the housing comprises at least one mounting apparatus which can interlockingly engage with a corresponding mounting apparatus of a mixing auger. For example, undercuts can be provided in the mixing auger (for example a T slot or a dovetail slot), into which the mounting apparatus of the housing can be introduced in order to mount the magnet device on the mixing auger. It is also possible that the housing has at least one undercut and that a corresponding mounting apparatus of the mixing auger is introduced into this undercut in order to mount the magnet device on the mixing auger.

The separator can for example butt against the housing by means of a hinge and thus be a swivelling part of the housing. It is also possible that the separator is held in a guide on housing so that it can be moved translationally. The at least one magnet can accordingly be movably mounted in the housing. For example, the magnet can be swivelled within the housing and/or moved translationally.

The magnet can be designed in particular to be mounted on a mixing auger, in a mixing hopper and/or on a discharge means (in particular discharge belt conveyor). Mounting can be implemented directly or indirectly. For indirect mounting, the at least one magnet can be held in a magnet holder and/or in a housing, wherein the magnet holder and/or the housing can be designed to be mounted on the mixing auger, in a mixing hopper (in particular on the hopper wall) and/or on a discharge means (in particular discharge belt conveyor). The separator is movably designed in this case in order to be brought from the first operating position into the second operating position. Therefore, the separator can be moved relative to the magnet (and thus relative to the mixing auger, the mixing hopper and/or the discharge means (depending on mounting location)). The movement can be a rotational movement (or swivelling movement) and/or a translational movement. Combinations of rotation and translation are also possible.

Similarly, the separator can be designed to be mounted on a mixing auger, in a mixing hopper and/or on a discharge means (in particular discharge belt conveyor). Mounting can be implemented directly or indirectly. For indirect mounting, the at least one separator can be held on a housing or housing part, wherein the housing can be designed to be mounted on the mixing auger, in a mixing hopper and/or on a discharge means. The magnet can be movably designed in this case in order to be brought from the first operating position into the second operating position. Therefore, the magnet can be moved relative to the separator (and thus relative to the mixing auger, the mixing hopper and/or the discharge means (depending on mounting location)). The movement can be a rotational movement (or swivelling movement) and/or a translational movement sein. Combinations of rotation and translation are also possible.

The separator can comprise at least one entrainment element. In particular, the at least one entrainment element can project from the separator in a direction which points away from the at least one magnet in the first operating position. The entrainment element can be, for example, a rib, a web, an edge, a pin, a bolt and/or the like. When the separator is brought from the first into the second operating position, the at least one entrainment element can prevent separated metal parts that adhere to the separator from slipping off the separator and then adhering directly to the magnet. The entrainment element thus ensures that adherent metal parts are moved together with the separator from the first into the second operating position. This can make it easier to remove these adherent metal parts from a feed mixing wagon or from the magnet device.

The magnet device can furthermore comprise a gripping element. This gripping element can be coupled to the at least one magnet or the separator in order to be able to move the at least one magnet or the separator from the first operating position into the second operating position. In particular, the gripping element can be removable. A removable gripping element can, for example, be coupled only to the separator in order to move the separator from the first into the second operating position (and back). For normal mixing operation of the feed mixing wagon, the separator can be removed so as not to disrupt the mixing operation. The removable gripping element can, for example, be pushed onto the separator, latched to the separator or reversibly connected in some other way.

In one aspect of the invention, the gripping element (removable or permanently connected) can be a swivelling lever. Swivelling the gripping element would then lead to a corresponding swivelling movement or rotational movement of the magnet or of the separator. Similarly, the gripping element can be used to simplify a translational movement of the magnet or of the separator. To this end, the gripping element can be pulled for example, so that the magnet or the separator is also moved.

Furthermore, a transmission element can be arranged between the gripping element and the at least one magnet or between the gripping element and the separator. The transmission element (for example a lever) is used to reduce the force that must be applied to the gripping element in order to move the at least one magnet/the separator from the first into the second operating position. In this way, the change from the first into the second operating position can still be performed manually even if very powerful magnets are used and/or a great many metal parts have been separated.

The magnet device can also comprise a latch element. The latch element can be designed to fix the at least one magnet or the separator in the first and/or second operating position. This simplifies the separation of metal parts in the first operating position on the one hand and the removal of separated metal parts in the second operating position on the other hand. The latch element can, for example, be magnetic and interact with the magnet of the magnet device in order to secure the first operating position. Alternatively, the latch element can interlockingly engage with a corresponding latch element in order to secure the first and/or second operating position.

The separator can shield the at least one magnet in the first operating position on at least one side, or on at least two sides, on at least three sides, on at least four sides, on at least five sides, or on at least six sides.

If the separator shields the at least one magnet on one side, it can be provided, for example, as a substantially flat cover of a housing of the magnet device. If the separator shields the at least one magnet on a plurality of sides, for example on two, on three, on four, on five, or on six sides, it can be a bent sheet metal part, an (injection-) moulded part or a deep-drawn part. It is likewise possible that the separator is composed of a plurality of individual parts. The individual parts can be connected to one another (for example welded, adhesively bonded, screwed, riveted, etc.) in order to form the separator.

The object is furthermore achieved by a mixing auger, in particular by a vertical mixing auger, for a feed mixing wagon or a stationary feed mixer. The mixing auger comprises an auger shaft that can rotate about a rotational axis and at least one first auger flight helically extending around the auger shaft. The mixing auger also comprises at least one magnet device, as described above. The magnet device is used to separate metal parts from a feed during the mixing process. By attaching the magnet device to the mixing auger, the magnet device is moved with the mixing auger when the latter rotates. In this way, any magnetic metal parts in the feed to be mixed can be effectively separated and ultimately removed.

In particular, a ramp element projecting upwards beyond the first auger flight can be arranged on the first auger flight of the mixing auger, wherein the magnet device is arranged at least partially in an interspace between the first auger flight and the ramp element, or is arranged behind and adjoining the ramp element as viewed in the direction of revolution of the mixing auger. In particular, the magnet device protrudes upwards at most as far as the ramp element protrudes beyond the auger flight.

Due to this arrangement of the magnet device in the region of the auger flight, metal parts can be separated particularly effectively from the feed to be mixed during the mixing process. As a result, animals are particularly effectively protected from inadvertently consuming metal parts. In addition, damage due to metal parts getting wedged inside the feed mixing wagons is avoided. Furthermore, the magnet device is arranged on the auger flight in the manner described in such a way that frictional resistance between the mixing auger and the feed is not or not significantly increased.

The mixing auger can also comprise a second auger flight which precedes the first auger flight in a base region of the mixing auger (in relation to the direction of rotation of the mixing auger). The second auger flight can comprise a trailing closing edge on which the magnet device is arranged. The trailing closing edge is, for example, angled in relation to the second auger flight (for example by at least 45°, or at least 60° or at least 90°). The magnet device can be arranged on this closing edge in such a way that it does not protrude beyond the auger flight. This also guarantees good separation and the mixing process is not or is barely disrupted by the magnet device.

In addition, the magnet device can be arranged on the mixing auger in such a way that the separator, and thus the area to which the metal parts to be separated adhere, has substantially the same pitch as the auger flight in the neighbouring region of the magnet device. This area can be flush with the top side of the auger flight or run slightly recessed in relation thereto (for example recessed by at least 1 cm, or recessed by at least 3 cm, or recessed by at least 5 cm). As a result, the feed slides particularly easily over the magnet device and any adherent metal parts.

As an alternative to this, it is also possible that the magnet device is arranged on the mixing auger in such a way that the separator, and thus the area to which the metal parts to be separated adhere, is angled by at least 45°, or at least 60° or at least 90° in relation to the surface of the auger flight in the neighbouring region of the magnet device. This can particularly effectively prevent the metal parts separated by the magnet device from being stripped off the magnet again by the feed as it passes by.

In particular, the magnet device (or the at least one magnet of the magnet device) can extend in a radial direction over 80% to 100% of the width of the auger flight. This can bring about particularly effective separation of metal parts.

According to a further aspect, a plurality of magnet devices of the type described above are provided which are mounted on the (first and/or second) auger flight offset relative to one another in the radial direction of the mixing auger. In this case, the magnet devices do not have to extend over the entire width of the auger flight.

The object is furthermore achieved by a feed mixing wagon. The feed mixing wagon can be a trailed or a self-propelled feed mixing wagon. The feed mixing wagon comprises a chassis and a feed mixing wagon hopper (also referred to as a mixing wagon hopper), wherein the feed mixing wagon hopper is arranged on the chassis.

The feed mixing wagon furthermore comprises at least one mixing auger for mixing feed and at least one magnet device for separating metal parts from the feed during the mixing process, wherein the magnet device is embodied as described above.

The object is furthermore achieved by a feed mixer which comprises a mixing hopper and a mixing auger for mixing feed, wherein the mixing auger is arranged in the mixing hopper. The stationary feed mixer comprises the at least one magnet device as described above for separating metal parts from the feed during the mixing process.

The magnet device can in particular be arranged on one of the mixing augers or the mixing auger of the feed mixing wagon, in the feed mixing wagon hopper (in particular on a hopper wall, preferably in the base region of the hopper wall), on a discharge means (in particular discharge belt conveyor) of the feed mixing wagon and/or at another suitable point on the feed mixing wagon. The feed mixing wagon can also comprise a plurality of magnet devices. These can be arranged at different points and/or on different components of the feed mixing wagon (e.g. on a mixing auger, in a mixing hopper (or on a hopper wall), and/or on a discharge means, in particular discharge belt conveyor).

The object is furthermore achieved by a method for removing magnetic metal parts from a feed mixing wagon or from a stationary feed mixer. The method comprises the following steps:
mixing feed by means of a feed mixing wagon or a stationary feed mixer, as described above, wherein the magnet device is in the first operating position;
separating magnetic metal parts onto the magnet device;
moving the at least one magnet or the separator from the first into the second operating position, and
removing separated metal parts from the magnet device and from the feed mixing wagon hopper of the feed mixing wagon or from a mixing hopper of the stationary feed mixer.

### BRIEF DESCRIPTION OF THE FIGURES

The appended figures show preferred embodiments of the invention. The appended figures are briefly explained in the following.

In the figures:

FIG. 1A shows a schematic illustration of a mixing auger with a magnet device;

FIG. 1B shows a detail view of the mixing auger from FIG. 1B;

FIG. 1C shows a variant of a mixing auger;

FIG. 2A shows a schematic illustration of a magnet device according to a first embodiment;

FIG. 2B shows another illustration of the magnet device from FIG. 2A;

FIG. 3A shows schematic illustrations of a magnet device according to a second embodiment;

FIG. 3B shows schematic illustrations of a magnet device according to a third embodiment;

FIG. 3C shows schematic illustrations of a magnet device according to a fourth embodiment;

FIG. 4A shows a schematic illustration of a magnet device according to a fifth embodiment;

FIG. 4B shows a schematic illustration of a magnet device according to a sixth embodiment;

FIG. 5 shows a schematic illustration of a feed mixing wagon;

FIG. 6 shows a schematic illustration of a self-propelled feed mixing wagon, and

FIG. 7 shows a schematic flow chart of a method.

### DETAILED DESCRIPTION OF THE FIGURES

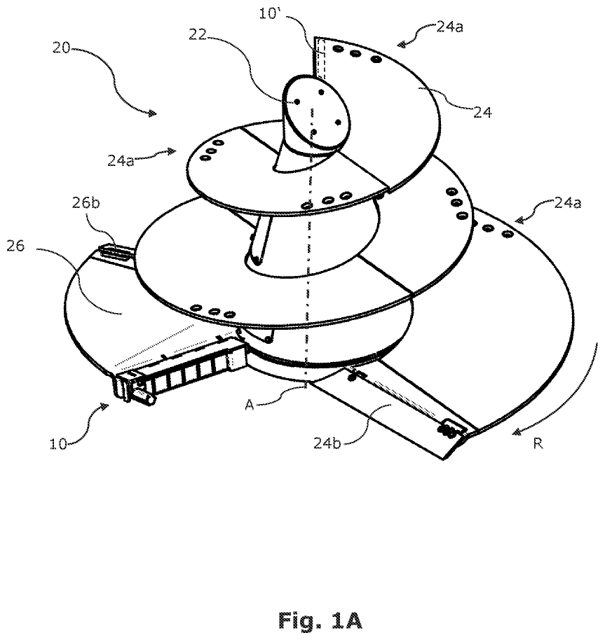

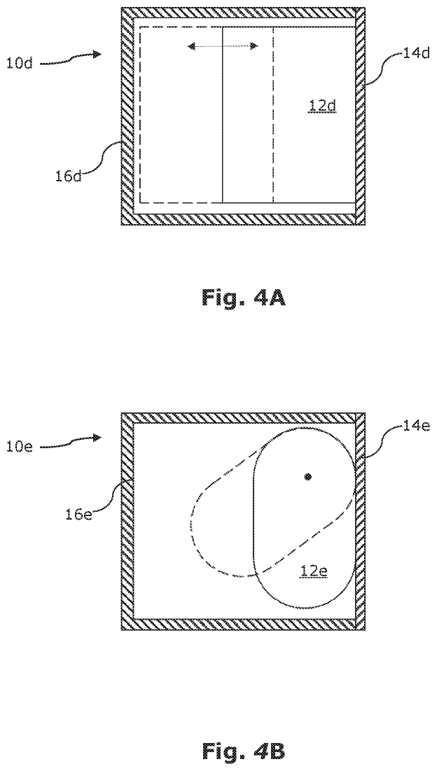

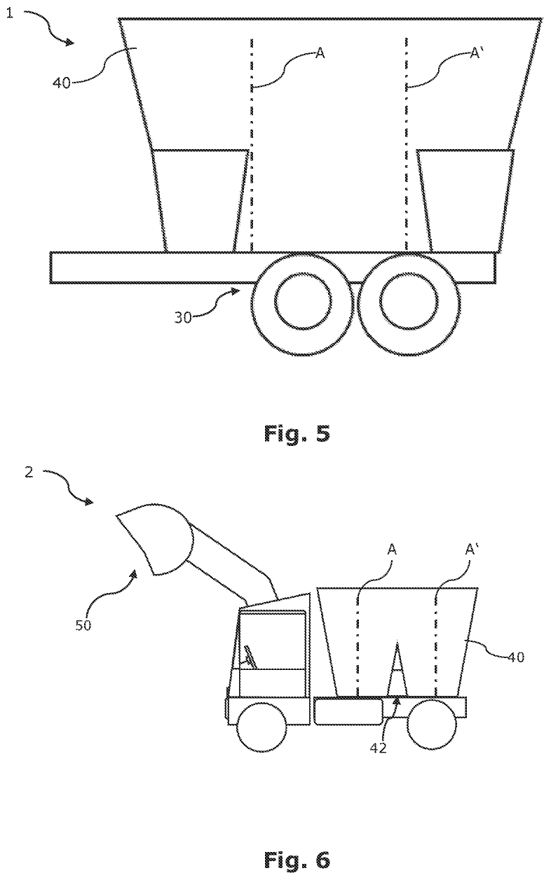

FIG. 1A shows a schematic illustration of a mixing auger 20 with a magnet device 10. The mixing auger 20 shown is a vertical mixing auger and can be used in a feed mixing wagon 1, 2, as is shown in FIGS. 5 and 6, or in a stationary feed mixer. The mixing auger 20 is used to mix animal feed, such as grass silage, maize silage, hay, concentrated feed and the like.

The mixing auger 20 comprises an auger shaft 22 that can rotate about a rotational axis A. To mix feed, the mixing auger 20 is rotated in a direction of rotation R. A first auger flight 24 extends helically around the auger shaft 22. Holders, for example blade holders 24a, can be arranged on the auger flight 24. Blades can be attached to the blade holders 24a. These blades are rotated together with the auger flight 24 and are used to chop up the feed. The auger flight 24 can be multipartite, or integrally moulded as one part. In addition, a scraper bar 24b, which precedes the auger flight 24 in the direction of rotation R, can be arranged in the base region of the first auger flight 24. This scraper bar 24b ensures that any feed lying on the base is picked up and mixed by the mixing auger 20.

To separate metal parts from the feed to be mixed, a magnet device 10 is arranged on the mixing auger 20 and rotates with the mixing auger 20. The magnet device 10 shown here is arranged in the base region of the mixing auger 20. Alternatively or additionally, a magnet device 10 can be arranged on the upper end, in particular on the free upper end of the auger flight 24. The region for the alternative or additional arrangement of a magnet device 10′ is denoted in FIG. 1A by a dashed line.

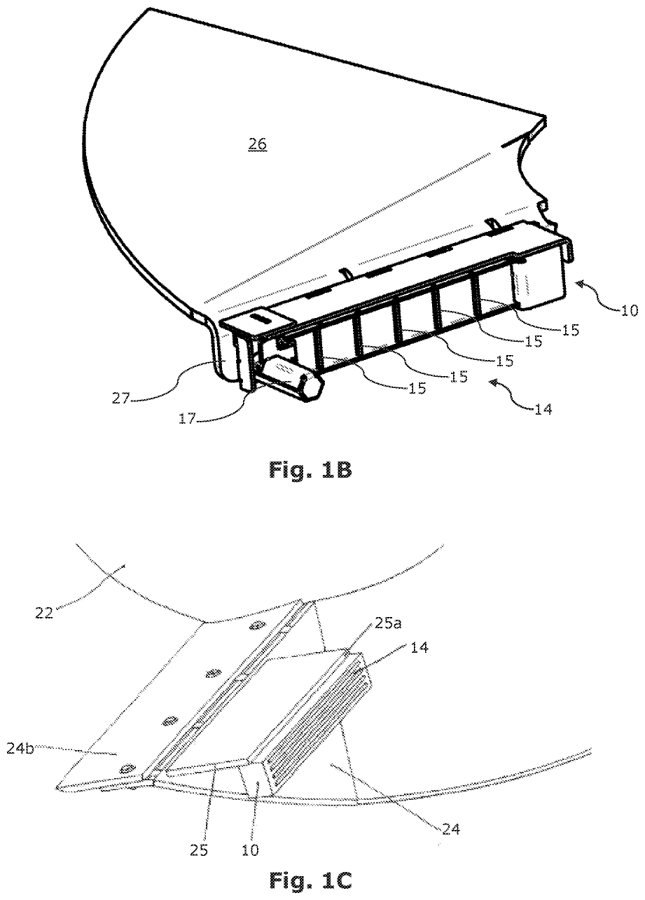

The mixing auger 20 shown in FIG. 1A has a second auger flight 26. The second auger flight 26 is shown in the detail in FIG. 1B. The second auger flight 26 precedes the first auger flight 24 in the direction of rotation and is arranged in a base region of the mixing auger 20. A scraper bar 26b can also be arranged on the second auger flight 26 in the base region and precedes the second auger flight 26 in the direction of rotation R. The second auger flight 26 furthermore comprises a trailing closing edge 27. The magnet device 10 is arranged on this closing edge 27. The trailing closing edge 27 is angled in relation to the second auger flight 26 by approximately 90° in the embodiment shown. This angle is merely an example. In other embodiments, the closing edge 27 can be angled at another angle (for example approx. 45°). The magnet device 10 is arranged on the closing edge 27 in such a way that it does not protrude beyond the auger flight 26. The magnet device 10 is shown in detail in FIGS. 2A and 2B and described in detail with reference to these figures.

In particular, in the embodiment shown in FIGS. 1A and 1B, the magnet device 10 is arranged on the mixing auger 20 in such a way that a separator 14 of the magnet device 10, and thus the area to which the metal parts to be separated adhere, is angled by approximately 90° in relation to the surface of the auger flight in the neighbouring region of the magnet device. Here, the separator 14 and the trailing closing edge 27 are thus arranged substantially in parallel.

FIG. 1C shows a further embodiment of the mixing auger 20. Here, the magnet device 10 (or a further magnet device 10) is arranged for example on the first auger flight 24. In addition, an upwardly projecting ramp element is arranged on the first auger flight 24. The magnet device 10 is arranged in this embodiment at least partially in an interspace between the first auger flight 24 and the ramp element 25. It is also possible to arrange the magnet device 10 behind and adjoining the ramp element 25 as viewed in the direction of revolution R of the mixing auger 20.

In FIG. 1C, the magnet device 10 protrudes upwards at most as far as the ramp element 25 protrudes beyond the auger flight 24. The magnet device is arranged somewhat recessed in FIG. 1C, so that a small recess 25a is created between the top side of the magnet device 10 and the ramp element 25. The recess can, for example, be at least 1 cm, or at least 3 cm, or at least 5 cm.

The magnet device 10 in FIG. 1C could also be rotated, so that the separator 14, and thus the area to which metal parts to be separated adhere, has substantially the same pitch as the auger flight 24 or as the ramp element 25 in the neighbouring region of the magnet device 10.

FIG. 2A is a schematic illustration of a magnet device 10 according to a first embodiment. This magnet device 10 is also shown in FIGS. 1A and 1B. The magnet device 10 is shown in FIG. 2A in the first operating position; the magnet device 10 is shown in FIG. 2B in the second operating position.

The magnet device 10 comprises at least one magnet 12 and a separator 14. The separator 14 and the at least one magnet 12 are arranged so that they can move relative to one another. Here, the separator 14 can be pushed onto the magnet and pulled by the latter (translational movement) in order to be brought from a first operating position (FIG. 2A) into a second operating position (FIG. 2B).

The separator 14 is arranged in the first operating position such that it shields the at least one magnet 12. In the first operating position, the metal parts to be separated from the feed are thus pulled by means of the magnet 12 onto the separator 14 and held there, but cannot reach the magnet 12 directly. The separator 14 separates the metal parts to be separated from the magnet 12. In the second operating position, the separator 14 is pulled away from the magnet 12 and is therefore spaced further apart than in the first operating position. The adherent metal parts to be separated can be pulled off together with the separator 14. Thus, the metal parts can be easily removed.

The separator 14 shown here surrounds the magnet 12 on five sides and thus shields it spatially from the metal parts. Since the separator 14 is preferably non-magnetic or only weakly magnetic, it can be pulled off the magnet in a particularly simple manner. Here, the separator 14 can be manufactured from stainless steel (e.g. 1.4301), for example.

The magnet device 10 furthermore comprises a housing 16 on which the magnet 12 is held. The housing 16 is used for mounting on a mixing auger, on a hopper wall and/or on a discharge means, such as a discharge belt conveyor.

A plurality of entrainment elements 15 (in the form of webs here) are arranged on the separator 14. The entrainment elements 15 project from the separator 14 in a direction which points away from the at least one magnet 12 in the first operating position. The entrainment elements prevent any adherent metal parts from slipping off the separator and being pulled onto the magnet 12 when the separator 14 is brought from the first into the second operating position.

The magnet device furthermore comprises a gripping element 17 which is coupled or connected to the separator 14. Said gripping element is used to grip the separator 14 and to move the latter from the first operating position into the second operating position. The gripping element 17 can be permanently connected to the separator 14 or be removable. A removable gripping element can only be coupled to the separator 14, for example, in order to move the separator from the first into the second operating position (and back). The separator 14 can be removed for normal mixing operation of the feed mixing wagon.

The gripping element 17 can be pushed onto the separator 14, latched to the separator or reversibly connected thereto in some other way (e.g. screwed on, secured with a cotter pin, by means of bayonet closure).

The magnet device 10 also comprises a latch element 19 and a complementary latch element 18. The latch element 19 is provided on the separator 14 and designed to fix the separator 14 in the first operating position. The latch element 19 shown in FIGS. 2A and 2B can interlockingly engage with a corresponding latch element 18 of the housing 16 in order to secure the first operating position.

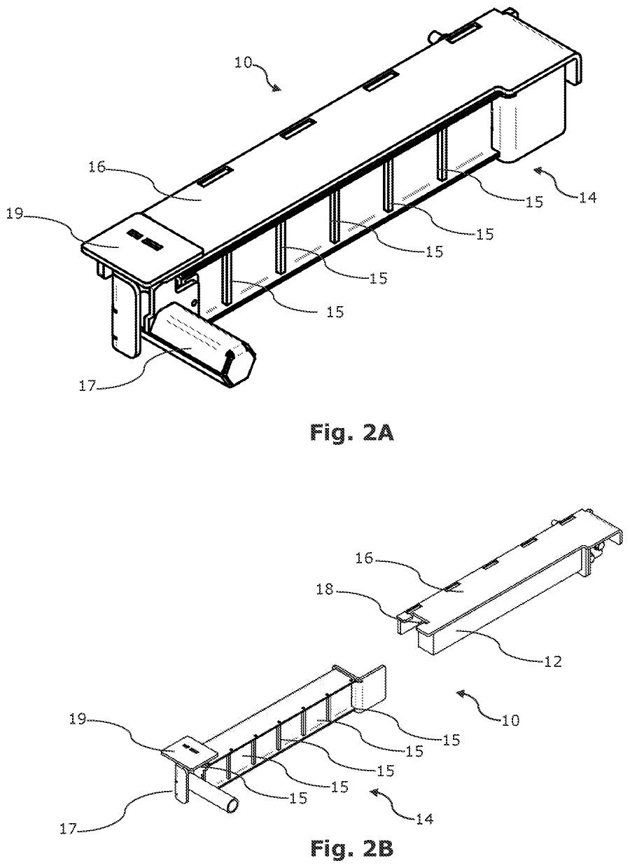

FIGS. 3A to 3C show further schematic illustrations of possible magnet device 10a, 10b, 10c, in which the separator 14a, 14b, 14c is moved relative to the magnet 12a, 12b, 12c (swivelling movement). The magnet devices are arranged here as an example on an auger flight 26 as described with reference to FIGS. 1A and 1B, but can also be arranged on other components of a feed mixer wagon or a stationary feed mixer. The first operating position is shown in the illustration on the left, and the second operating position is shown in the illustration on the right. In the illustrations in FIGS. 3A to 3C, the separator 14a, 14b, 14c is brought from the first into the second operating position by a swivelling movement. In FIG. 3A, the longitudinal side of the separator 14a is connected to a housing 16a such that it can swivel. The separator 14a shields the magnet 12a on one side. The magnet 12a is surrounded by the housing 16a on the other sides.

In FIG. 3B, the transverse side of the separator 14b is connected to a housing 16b such that it can swivel. The separator 14b shields the magnet 12b on one side. The magnet 12b is surrounded by the housing 16b on the other sides.

In FIG. 3C, the longitudinal side of the separator 14c is connected to the magnet 12c or a baseplate (not shown) such that it can swivel. The separator 14c shields the magnet 12c on five sides. The magnet 12c is in contact with the closing edge 27 of the auger flight 26 at the rear.

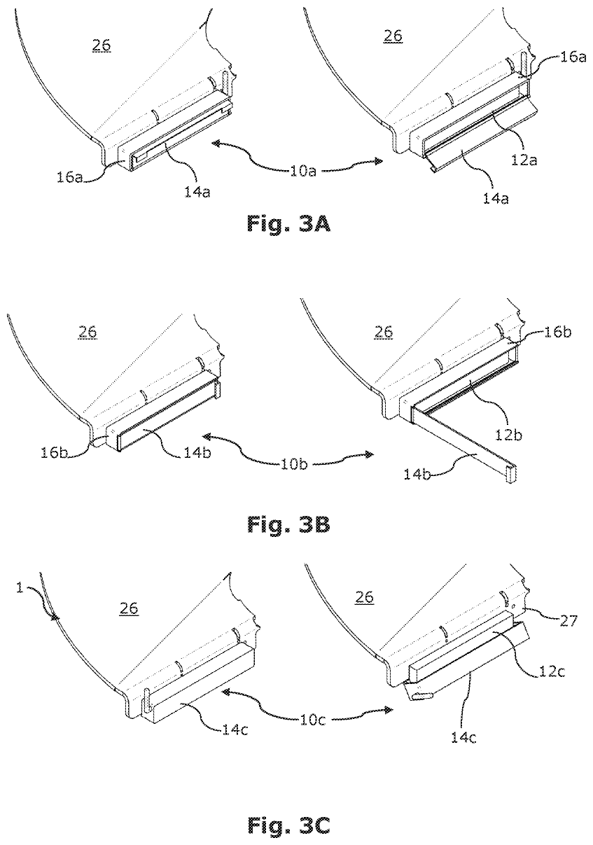

FIGS. 4A and 4B show further schematic illustrations of possible magnet device 10d and 10e in a sectional view. The magnet 12d, 12e is moved relative to the separator 12d, 12e in this magnet device 10d and 10e. The separator 12d, 12e can also be immovably connected to the housing 16d, 16e. The magnet 12d in FIG. 4A can be moved translationally away from the separator 12d. In the first operating position, the magnet 12d is in contact with the separator 14d. In the second operating position (dashed illustration of the magnet 12d), the magnet 12d and the separator 14d are spaced apart from one another. Any adherent metal parts can easily be removed in the second operating position. The magnet 12e in FIG. 4B can be rotated (swivelled) away from the separator 12e. In the first operating position, the magnet 12e is in contact with the separator 14e. In the second operating position (dashed illustration of the magnet 12e), the magnet 12e and the separator 14e are spaced apart from one another. Any adherent metal parts can easily be removed in the second operating position.

FIG. 5 is a schematic illustration of a feed mixing wagon 1. The feed mixing wagon 1 shown is a towed feed mixing wagon which can be hitched to a vehicle (not shown), for example a tractor. The invention is not restricted to towed feed mixing wagons; it also relates to driven and (self-)propelled feed mixing wagons, as shown in FIG. 6. The feed mixing wagon 1 comprises a chassis 30 and a feed mixing wagon hopper 40, wherein the feed mixing wagon hopper 40 is arranged on the chassis 30. At least one mixing auger (here two) comprising a magnet device is arranged in the feed mixing wagon hopper 40. The at least one mixing auger can rotate about the axis A, A′ in order to mix feed in the feed mixing wagon hopper 40.

FIG. 6 shows a schematic illustration of a self-propelled feed mixing wagon 2. This comprises a feed mixing wagon hopper 40 and a discharge device 42 for dispensing feed. In addition, this self-propelled feed mixing wagon 2 comprises a feed pick-up device 50. This feed pick-up device 50 can comprise a silage cutter and a magnet device. At least one mixing auger (here two) comprising a magnet device is arranged in the feed mixing wagon hopper 40. The at least one mixing auger can rotate about the axis A, A′ in order to mix feed in the feed mixing wagon hopper 40.

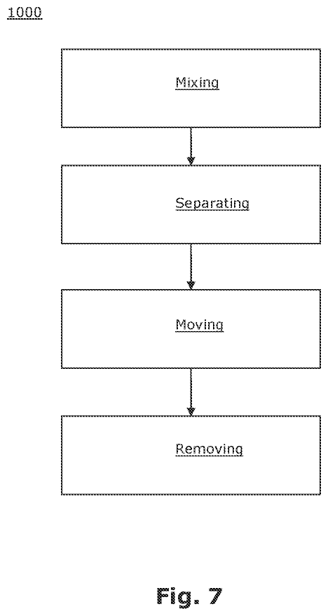

FIG. 7 a schematic flow chart of a method 1000 for removing magnetic metal parts from a feed mixing wagon 1, 2 or from a stationary feed mixer. The method comprising the following steps:
mixing 1100 feed by means of a feed mixing wagon 1, 2 or a stationary feed mixer, wherein the magnet device is in the first operating position;
separating 1200 magnetic metal parts onto the magnet device 10;
moving 1300 the at least one magnet 12 or the separator 14 from the first into the second operating position, and
removing 1400 separated metal parts from the magnet device 10 and from the feed mixing wagon hopper 40 of the feed mixing wagon 1, 2 or from a mixing hopper of a stationary feed mixer.

Before moving 1300 the at least one magnet 12 or the separator 14 from the first into the second operating position, the mixing auger can optionally be brought into a position from which a gripping element of the magnet device is easily accessible from outside the feed mixing wagon/the stationary feed mixer. For example, the mixing auger can be moved into a position in which the gripping element is positioned upstream of a feed ejector of the mixing wagon hopper/mixing hopper. The feed ejector is for example an opening from which the mixed feed can be dispensed or removed (e.g. by means of a discharge belt conveyor).

The present invention can of course also be implemented in ways other than those set out herein, without thereby affecting any essential features of the invention. The present embodiments are to be considered as illustrative and non-limiting in all respects, and any modifications falling within the scope of meaning and equivalence of the appended claims shall be included therein.

### LIST OF REFERENCES

1, 2 feed mixing wagon
10 magnet device
10′ magnet device
12 magnet
14 separator
15 entrainment element
16 housing
17 gripping element
18 complementary latch element
19 latch element
20 mixing auger
22 auger shaft
24 auger flight (first)
24a blade holder
24b scraper bar
25 ramp element
25a recess
26 auger flight (second)
26b scraper bar
27 closing edge
30 chassis
40 feed mixing wagon hopper
42 discharge device
50 feed pick-up device
A, A′ rotational axis
R direction of rotation

1. A magnet device for a feed mixing wagon or a stationary feed mixer, comprising:
at least one magnet; and
a separator, wherein
the separator and the at least one magnet are arranged so that they can move relative to one another in order to be brought from a first operating position into a second operating position,
wherein the separator is arranged in the first operating position relative to the at least one magnet in such a way that the separator shields the at least one magnet, so that metal parts to be separated from feed are pulled onto the separator by means of the magnet and held thereon, and
wherein the separator is spaced further apart from the at least one magnet in the second operating position than in the first operating position.

2. The magnet device according to claim 1, wherein the separator is not magnetic or is weakly magnetic.

3. The magnet device according to claim 1, wherein the magnet device comprises a housing which at least partially accommodates the at least one magnet, wherein the separator is part of the housing.

4. The magnet device according to claim 1, wherein the magnet is designed to be mounted on a mixing auger, in a mixing hopper and/or on a discharge means, and wherein
the separator is movably designed in order to be brought from the first operating position into the second operating position.

5. The magnet device according to claim 1, wherein the separator is designed to be mounted on a mixing auger in a mixing hopper and/or on a discharge means, and wherein the at least one magnet is movably designed in order to be brought from the first operating position into the second operating position.

6. The magnet device according to claim 1, the movement from the first operating position into the second operating position comprises a swivelling movement and/or a translational movement.

7. The magnet device according to claim 1, wherein the separator comprises at least one entrainment element, wherein the at least one entrainment element projects from the separator in a direction which points away from the at least one magnet in the first operating position.

8. The magnet device according to claim 1, wherein the magnet device furthermore comprises a gripping element which is coupled to the at least one magnet or the separator in order to move the at least one magnet or the separator from the first operating position into the second operating position, wherein the gripping element can be removable.

9. The magnet device according to claim 8, wherein a transmission element is arranged between the gripping element and the at least one magnet or the separator.

10. The magnet device according to claim 1, furthermore comprising a latch element which fixes the at least one magnet) or the separator in the first and/or second operating position.

11. The magnet device according to claim 1, wherein the separator shields the at least one magnet in the first operating position on at least one side, or on at least two sides, on at least three sides, on at least four sides, on at least five sides, or on at least six sides.

12. A mixing auger for a feed mixing wagon or a stationary feed mixer, wherein the mixing auger comprises the following:
an auger shaft that can rotate about a rotational axis;
at least one first auger flight helically extending around the auger shaft, and
at least one magnet device for separating metal parts from a feed during the mixing process, wherein the magnet device is embodied according to claim 1 and is moved with the mixing auger when the latter rotates.

13. The mixing auger according to claim 12, wherein:
a ramp element projecting upwards beyond the first auger flight is arranged on the first auger flight,
wherein the magnet device is arranged at least partially in an interspace between the first auger flight and the ramp element, or is arranged behind and adjoining the ramp element as viewed in the direction of revolution of the mixing auger,
wherein the magnet device protrudes upwards at most as far as the ramp element protrudes beyond the auger flight.

14. The mixing auger according to claim 12, wherein the mixing auger comprises a second auger flight which precedes the first auger flight in a base region of the mixing auger, wherein the second auger flight comprises a trailing closing edge on which the magnet device is arranged.

15. A feed mixing wagon, comprising a chassis and a feed mixing wagon hopper, wherein the feed mixing wagon hopper is arranged on the chassis,
the feed mixing wagon furthermore comprising at least one magnet device according claim 1 for separating metal parts from the feed during the mixing process.

16. A stationary feed mixer, comprising:
a mixing hopper;
a mixing auger for mixing feed, wherein the mixing auger is arranged in the mixing hopper, and
at least one magnet device according to claim 1 for separating metal parts from the feed during the mixing process.

17. A method for removing magnetic metal parts from a feed mixing wagon or a stationary feed mixer, the method comprising the following steps:
mixing feed by means of a feed mixing wagon according to claim 15, wherein the magnet device is in the first operating position;
separating magnetic metal parts onto the magnet device;
moving the at least one magnet or the separator from the first into the second operating position, and
removing separated metal parts from the magnet device and from the feed mixing wagon hopper of the feed mixing wagon or from a mixing hopper of a stationary feed mixer.
